(19) United States
(12) Patent Application Publication
(10) Pub. No.: US 2020/0285708 A1
(43) Pub. Date: Sep. 10, 2020

(54) CREATING AN ANALYSIS MODEL FOR STRUCTURAL ANALYSIS

(71) Applicant: Trimble Solutions Corporation, Espoo (FI)

(72) Inventors: Agnes Kopra, Espoo (FI); Tapio Kohonen, Espoo (FI)

(21) Appl. No.: 16/291,890

(22) Filed: Mar. 4, 2019

(51) Int. Cl. G06F 17/50; G06T 17/10

(52) U.S. Cl. CPC G06F 17/5004; G06T 17/10; G06F 17/5086

(57) ABSTRACT

Solutions how to automatically create analysis models for structural analysis from physical models are disclosed. For the purpose a concept of planes for creating analysis elements is introduced. For example, the planes may be created automatically to initial elements, which in turn may be created based on physical parts in a physical model, or at least based on load-bearing physical parts in the physical model. The planes are used to manipulate dimensions and/or positions of the initial elements so that the analysis elements created based on the initial elements will connect if corresponding physical parts are connected in the physical model.

### FIELD

The present invention relates generally to computer aided modeling of structures, and especially to analysis models for structural analysis.

### BACKGROUND ART

The development of data processing systems, computer and computer applications has transformed different manual processes into computerized processes. For example, there are computer applications for creating digital representations of different structures, like buildings. The digital representations are called herein physical models. Many of computational tools used in engineering for structural analysis use analysis models that comprise 1D analysis elements (stick-like analysis elements) and 2D analysis elements (polygon analysis elements) to represent structures, or at least load-bearing structures. To convert automatically a physical model, such as a 3D model of a building, to an analysis model comprising analysis elements is not a straightforward solution: while the actual structures, like columns and beams, connect in the physical model, corresponding analysis elements do not automatically connect in an analysis model created automatically from the physical model. One of the reasons is that the computerized process uses accurate geometry definition points of the physical model, and even a slight distance, like 0.1 mm, and/or the analysis element being created to a middle of a beam and a column instead of a bottom of the beam and a side of the column, for example, causes that the analysis elements created automatically by the computerized process are not connected. The problem arises only in realm of computer technology when analysis models are automatically created from physical models, since when users are creating manually, using a corresponding application, the analysis models, they create analysis elements so that they connect to each other.

### SUMMARY

The invention relates to methods, a program product, and an apparatus which are characterized by what is stated in the independent claims. The preferred embodiments are disclosed in the dependent claims.

An aspect introduces a concept of planes for creating analysis elements, wherein the planes are created automatically based on at least load-bearing physical parts in a physical model.

In an aspect the planes are created automatically to initial elements, which in turn are created based on physical parts in a physical model. The planes are used to manipulate dimensions and/or positions of the initial elements so that the analysis elements created based on the initial elements will connect if corresponding physical parts are connected in the physical model.

### BRIEF DESCRIPTION OF THE DRAWINGS

In the following different embodiments of the invention will be described in greater detail with reference to the attached drawings, in which:

FIGS. 1A and 1B are schematic diagrams depicting basic concepts;

FIG. 2 shows a simplified architecture of an exemplary system and a schematic block diagrams of some apparatuses;

FIGS. 3 to 7 illustrate different exemplary functionalities;

FIG. 8 is a schematic block diagram of an exemplary apparatus.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The present invention is applicable to any computer-aided modeling, and corresponding modeling applications (i.e. modeling programs), or any other system/applications configured or configurable to create (generate) analysis models from physical models of structures and/or to manipulate the analysis models. Examples of such applications are computer aided design applications and computer aided modeling applications, such as different Building Information Modeling (BIM) applications. Current BIM applications are used to plan, design, construct, operate and maintain diverse physical infrastructures, such as water, refuse, electricity, gas, communication utilities, roads, bridges, ports, tunnels, different buildings, etc.

Below different examples are explained without tying them to a specific application. It should be appreciated that various programming techniques, storage of data in memory and manners of modeling real world articles and implementing databases develop constantly. This may require extra changes in the invention. Consequently, all terms and expressions should be interpreted broadly, and they are intended to describe, not to restrict, the invention.

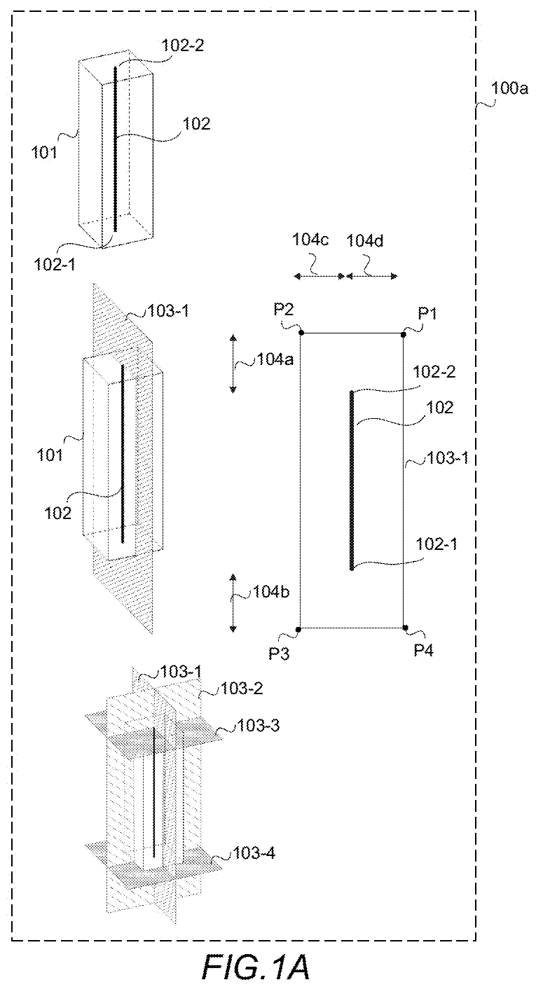

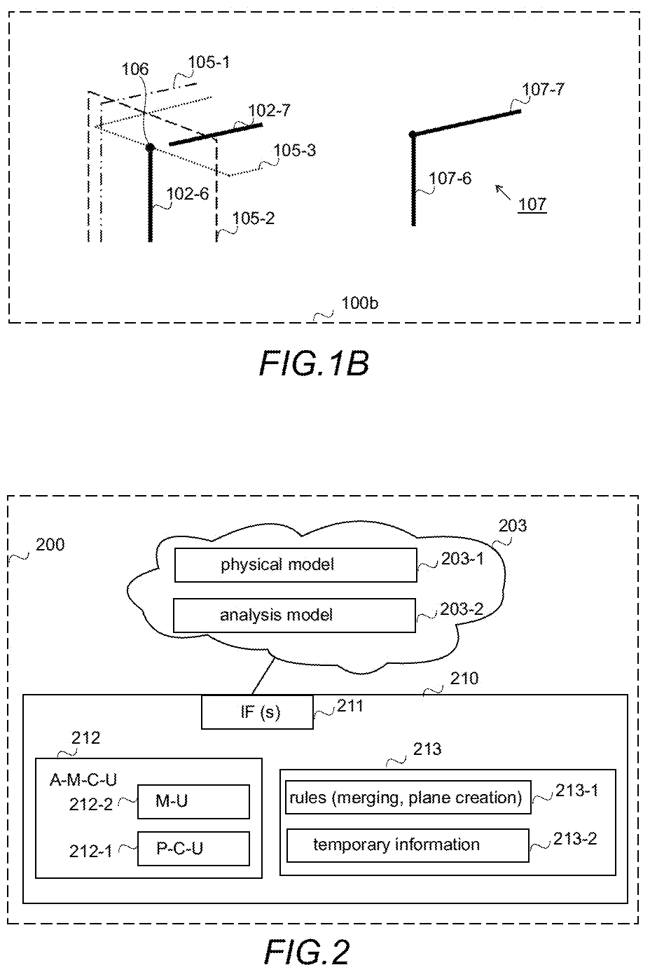

FIG. 1A is a schematic diagram depicting basic components 100a on a generalized level in an initial phase, the basic components being a physical part 101, an initial element 102 and a part plane 103-1, 103-2, 103-3, 103-4.

Typically, the physical model of the structure comprises one or more 3D objects that represent real-world articles forming the modelled structure. The physical part 101 in FIG. 1 represents a 3D object of an article in a physical model of a structure. It should be appreciated that herein “article” means an item that will or may exist in the real world or at least is planned to exist in the real world. A non-limiting list of examples of such items include steel beams, reinforced concrete beams, timber beams, steel columns, reinforced concrete columns, timber columns, timber walls, concrete walls, masonry walls, sandwich structure walls, concrete slabs and composite slabs.

In physical models, an article is modeled as a 3D object defining at least geometrical properties of the object and its location in the model. Typically, a 3D object is given its creation point or points, the amount of creation points depending on the article to be modeled and the modeling application used, and values for different parameters representing the physical values of the article. Examples of creation points include a starting point and an ending point of the object, or starting point and ending point of a reference line of an object, used for positioning the object, or creation points defining outlines of the objects. A plurality of properties can be associated with each object that can detail, in addition to the location and geometry of the object, the manner of connectivity of the object to other objects, materials used to, or to be used to, realize the object, such as concrete, wood, steel, and other suitable properties, possibly including information whether the object is a load-bearing object or a non-load-bearing object, and its connectivity. It should be appreciated that it bears no significance to the invention, how physical models, their objects and related information are created (generated), as long as information needed by an application to create (generate) an initial analysis model comprising initial elements is retrievable (obtainable) by the application from the physical model.

Below, term “physical part” is used as a synonym to a 3D object representing an article.

As can be seen from FIG. 1A, the initial element 102 for a longitudinal physical part, like a column or a beam, is a stick-like 1D representation of the corresponding physical part 101. An initial element for a planar physical part, like a wall or a slab, is a 2D polygon representation of the corresponding physical part. The initial element may be called an analysis part, or a reference line (1D representation)/reference plane (2D representation). The initial element may be created automatically based on creation points of the physical part, or the initial element may be created on a center line of the physical part, or according to a user input, possibly stored as a property of the object. For example, the user input may indicate that the initial element locates on one side of the physical element. Using the example of the physical part 101 in the column, the initial element may be created using a starting point and an ending point of the physical part 101. Regardless how the initial element is created, the 1D initial element 102 comprises two end points 102-1, 102-2. The end points may be called reference points.

For an initial element one or more part planes are created, using local coordinate system of the initial element either along the initial element 102 or on one end of the initial element 102. For 1D initial elements, each part plane 103-1, 103-2, 103-3, 103-4, is a finite rectangular plane created based on the initial element 102 and/or corresponding physical part 101 and offsets. For 2D initial elements, a part plane may be a polygon plane having the same shape as the physical part in the plane of its two biggest dimensions but extended with an offset, or always a rectangular plane. The rectangular plane may be created using maximum values of the physical part to create its extrema, which is then further extended by a corresponding offset. Outer boundaries of the rectangular part plane 103-1 are defined by four points P1, P2, P3 and P4. The points may be called definition points. For example, at the simplest, using the same offset (offset value, broadening value) “a”, 500 mm, for example, for all offsets 104a, 104b, 104c, 104d, for the initial member 102, having local coordinates x1, y1, z1 at the end point 102-1 and local coordinates x2, y2, z2 at the other end point 102-2, two vertical planes and two non-vertical planes may be defined planes with following definition points:
part plane 103-1, the one illustrated as a separate plane in 2D in FIG. 1, assuming 104c and 104d are offsets along local x-axis, 104a and 104b along local y-axis (part plane along the analysis element, vertical in the local coordinate system, so no z-axis offsets): P1 (x1+a, y1+a, z1), P2 (x1−a, y1+a, z1), P3(x2−a, y2−a, z2), P4 (x2+a, y2−a, z2)
part plane 103-2 (as the part plane 103-1 but in the illustrated example perpendicular to the part plane 103-1, so no x-axis offset): (P1 (x1, y1+a, z1+a), P2 (x1, y1+a, z1−a), P3(x2, y2−a, z2−a), P4 (x2, y2−a, z2+a)
part plane 103-3 (at one of the ends of the initial element, horizontal in the local coordinate system, so no y-axis offset): P1 (x1+a, y1, z1+a), P2 (x1−a, y1, z1+a), P3 (x1−a, y1, z1−a), P4(x1+a, y1, z1−a)
part plane 103-4 (parallel to the part plane 103-3, on the other end of the initial element): P1 (x2+a, y2, z2+a), P2 (x2−a, y2, z2+a), P3 (x2−a, y2, z2−a), P4(x2+a, y2, z2−a)

Naturally, different offsets values may be used for different part types and/or for vertical/non-vertical part planes, and even for one part plane, each of the offsets 104a, 104b, 104c, 104d may have a different value. In the above example, as well as in other examples herein, it is assumed that vertical means along local y-axis, which herein is assumed to be a longitude axis of a longitudinal physical part. However, it is obvious for one skilled in the art how to implement the examples when another kind of definitions for coordinate system is used.

FIG. 1B is a schematic diagram depicting basic components 100b on a generalized level after the initial phase, the basic components being an analysis plane, illustrated by analysis planes 105-1, 105-2, 105-3, an analysis node 106, and an analysis element, illustrated by analysis elements 107-6, 107-7, in an analysis model 107.

An analysis plane 105-1, 105-2, 105-3 is created by merging two or more part planes together, or if no mergeable part plane exits, from the part plane, as will be described in more detail below. For example, analysis plane 105-2 may have been created by merging a part plane of an initial element 102-7 with a vertical part plane of an initial element 102-6. An analysis plane 105-3 may have been created by merging a top part plane of the initial element 102-7 with an end part plane of the initial element 102-6 even though in FIG. 1B the end of the analysis plane 105-3 aligns with the initial element 102-6 to more clearly illustrate the position of the analysis node 106. An analysis plane 105-1 may have been created from a corresponding part plane of the initial element 102-6 without merging.

The analysis node 106 is an intersection point of three analysis planes 105-1, 105-2 and 105-3. In the illustrated example of FIG. 1B, the analysis node 106 corresponds to one of the end points of the initial element 102-6.

Using the initial elements 102-6, 102-7, assuming that corresponding physical parts are to be connected, an analysis model 107 is formed, as will be described in more detail below. The analysis model comprises analysis elements 107-6, 107-7, which correspond to the initial elements and are snapped to the analysis node. As can be seen from the example illustrated, an analysis model created automatically from the initial elements 102-6, 102-7, as is done in prior art solutions, would be a faulty analysis model in which the elements 102-6, 102-7 in the analysis model would not touch each other.

FIG. 2 illustrates a simplified system describing only some logical units with their operative connections, the implementation of which may deviate from what is presented. It is obvious to a person skilled in the art that the system may also comprise other functions and structures that need not be described in greater detail here. The more detailed structure of the system is irrelevant to the actual invention.

The modeling system 200 illustrated in FIG. 2 is a simplified modeling system that comprises one or more apparatuses 210 (only one shown in FIG. 2) that is connectable to one or more data storages 203.

The apparatus 210 may be any computing device that can be configured to perform at least part of functionalities described below to create analysis models. Examples of such apparatuses include a user terminal or a workstation, such as a laptop, a smartphone, a personal computer, a tablet computer, a field device, a virtual reality device, augmented reality (AR) interface device, a web client, or a server, like a cloud server or a grid server. For creating analysis models the apparatus 210 comprises at least an analysis model creation unit (A-M-C-U) 212, and in the memory 213 different rules 213-1 for the analysis model creation unit, and memory area 213-2 to maintain different information temporarily when the analysis model creation unit, or any corresponding unit or sub-unit, is run to create an analysis model.

In the illustrated example, the analysis model creation unit (A-M-C-U) 212 comprises two sub-units for providing enhanced analysis model creation. For example, a prior art analysis model creation unit may be upgraded by means of the sub-units to provide the functionality described herein. The sub-units are a plane creation unit (P-C-U) 212-1 for creating part planes to initial elements, and a merging unit (M-U) 212-2 for creating analysis planes and analysis elements according to rules relating to merging. In other implementations, the sub-units may have been integrated together, or the functionality is divided into even more specific sub-units, or there are no sub-units at all.

An example of a rule is “use value X as the offset value for part planes”. Other examples of rules 213-1 for the plane creation unit and for the merging unit are described below in detail. Examples of temporary information 213-2 include information on planes (part planes and analysis planes), such as definition points, end points, analysis nodes, associated with information on the one or more physical parts corresponding to the one or more initial elements to which the part planes were created. The information on the physical parts may comprise information on connectivity to other physical parts, information on whether or not the physical part is a load-bearing part, etc. In case of a non-load bearing part further information, like for a bracing information that it is a support part, may be provided.

The apparatus 210 can be further configured to create and/or modify and/or edit and/or change and/or view and/or output other information relating to structural analysis and/or physical models. For example, one of the interfaces 211 may be a user interface that is the interface of a user to the modeling system, and another one an interface towards the data storage 203, to retrieve physical models 203-1 and/or to publish (store) analysis models 203-2, or physical models.

The data storage 203 comprises one or more physical models 203-1, and one or more analysis models 203-2. Depending on an implementation, the analysis models comprises analysis elements and/or analysis planes and/or part planes, possibly with information indicating physical parts. The data storage 203 may be an external data storage, as in the example of FIG. 2, or an internal data storage, or a combination of an internal and external data storage. In other words, the data storage 203 may be any kind of conventional or future data repository, including distributed and centralized storing of data, managed by any suitable management system forming part of the modeling system (modeling environment). An example of distributed storing includes a cloud-based storage in a cloud environment (which may be a public cloud, a community cloud, a private cloud, or a hybrid cloud, for example). Cloud storage services may be accessed through a co-located cloud computer service, a web service application programming interface (API) or by applications that utilize API, such as cloud desktop storage, a cloud storage gateway or Web-based content management systems. However, the implementation of the data storage, the manner how data is stored, retrieved and updated, are irrelevant to the invention. Further, the modeling system may comprise several terminals and servers with databases, which are preferably integrated to be visible to the user as one database and one database server.

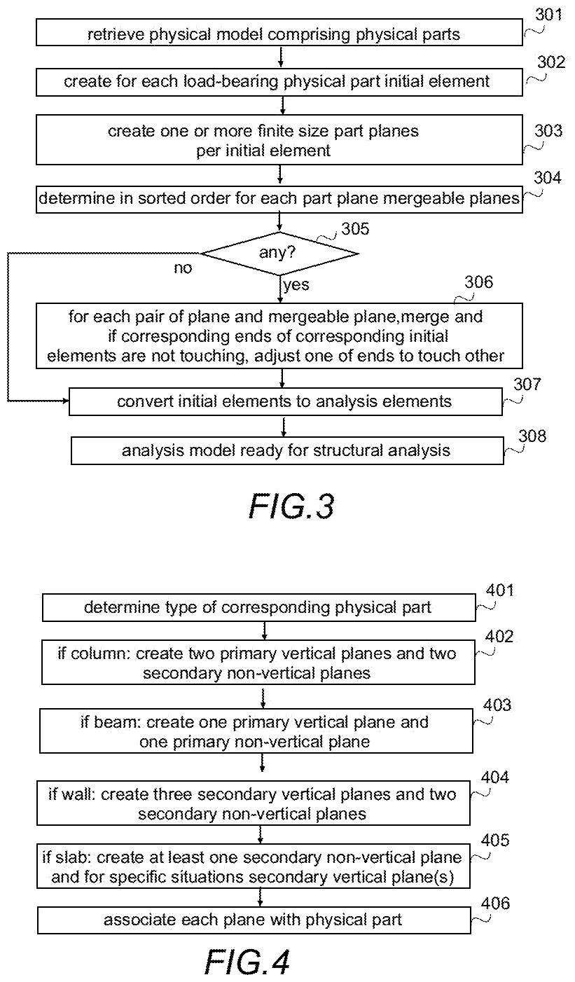

FIG. 3 is a flow chart illustrating an example of a functionality of an apparatus, or more precisely the analysis model creation unit. In the illustrated example, part planes are created for load-bearing physical parts, not for non-load-bearing physical parts. Each physical part in the physical model may comprise as one of its properties information on whether it is a load-bearing or non-load bearing part and/or default values may be used. An example of use of default values is that the load-bearing frame is by default a beam-column structure. This means that beams and columns are by default load-bearing physical parts and other physical parts by default non-load-bearing physical parts. Naturally, if a default value is used for categorizing whether a part is load-bearing or non-load bearing, the default value may be overcome/replaced by indicating another kind of load bearing structure than the default one, or if a physical part is associated with load bearing information.

Referring to FIG. 3, the apparatus is running an application in which analysis models may be created. In the illustrated example, the creation starts by retrieving in step 301 a physical model comprising physical parts. The physical model may comprise only load-bearing physical parts, or both load-bearing and non-load-bearing physical parts. Then for each load-bearing physical part a corresponding initial element is created in step 302. As explained above with FIG. 1A, the initial element is usually created based on creation points of the physical part, but not necessarily on the creation points. It bears no significance to the invention how the initial elements are created, and any known or future method may be used. Therefore, there is no need to describe that in more detail. A model comprising initial elements may be called an initial analysis model.

Then the part planes are created in step 303 using the one or more offset values: one or more finite size part planes for each initial element, for example as described with FIG. 1A. The thus created model comprising initial elements and part planes may be called as an intermediate analysis model. Once the part planes have been created, for each part plane in a sorted order mergeable planes, if any exits, are determined in step 304. A mergeable plane is a part plane that may be merged to another part plane or to a plane formed by already merged planes. The rules in the memory are used to define what planes are considered as mergeable planes. A non-limiting list of examples of rules include that the planes should be within distance up to a specific value, like 300 mm, or a value depending on dimension/dimensions of object(s), from each other, the planes should be parallel and overlap at least partly, and the physical part corresponding to the initial element is touching (clashing), connected, or indicated to connect with at least one physical part associated with the other plane.

If any mergeable planes were found (step 305: yes), one of corresponding ends of corresponding initial elements is adjusted in step 306 to touch the other, unless they are not touching already. The adjusting may include that the location of the end point of an initial part in the model coordinate system is moved to touch the other end point of another initial part, possibly causing extension of the initial element whose end point is moved. However, no corresponding changes are made to the physical model.

Once that has been performed, analysis elements are created in step 307 based on the initial elements, or their end points, after possible adjustment, and the analysis model is ready (step 308) for structural analysis.

If there are no mergeable planes (step 305: no), the analysis elements are created in step 307 based on the initial elements.

FIG. 4 is a flow chart illustrating an example of a functionality of an apparatus, or more precisely the plane creation unit, the example illustrating how to create part planes after initial elements have been created, or after an initial element has been created and others are being created. The example illustrates processing of a single initial element. The plane creation unit may run a plurality of such processes in parallel and/or in serial. In the illustrated example it is assumed that the physical parts are associated with load-bearing information for the structural analysis. However, as described above, it is possible also to use default values, such as columns and beams are always load-bearing, other elements are not load-bearing. Further, in the basic rules used with the illustrated example, it is assumed that the physical part does not contain information, indicating possible movement limitations to end points of the initial element, compared to basic rules. However, it is a straightforward solution, based on the disclosed teaching, to take into account any movement limitation. For example, “move freely” may cause that a plane is secondary, even though according to the basic rule it would be primary. Further, even though in the illustrated example rules for creating part planes, described in steps 402 to 405, part planes are created to be either vertical or non-vertical in the local coordinate system of the initial element and they are classified either as primary or secondary planes, other sets of rules may be defined. For example, part planes can be created without classifying them, part planes can be classified in more detail, and/or a part plane may be horizontal and/or non-horizontal.

Referring to FIG. 4, a type of a physical part corresponding to the initial element, which is being processed, is determined in step 401, and based on the type, different part planes are created, using the principles described with FIG. 1A

If the type is a column, the basic rule is that two vertical part planes, classified as primary planes, and two non-vertical part planes, classified as secondary planes, are created in step 402. The vertical part planes are created along the initial element, and the non-vertical part planes on both ends of the initial element. The non-vertical part planes are preferably, but not necessarily aligned with corresponding end plane of the physical part.

If the type is a beam, the basic rule is that one vertical part plane and one non-vertical part plane, both classified as primary planes, are created in step 403. The two part planes are created along the initial element. The vertical part plane is preferably, but not necessarily aligned with a corresponding side of the physical part. Naturally, it is possible to create further part planes, for example as secondary part planes, at the ends of the initial elements.

If the type is a wall, the basic rule is that three vertical part planes, classified as secondary planes, and two non-vertical part planes, classified as secondary planes are created in step 404. Two of the three vertical part planes are created at the start and end of the physical part modeling the wall, preferably to be perpendicular to the physical part. The non-vertical planes are created at bottom and at top level of the physical part representing the wall. The levels can be defined by using extrema if the physical part has a horizontal segment, for example.

If the type is a slab, the basic rule is that at least one non-vertical part plane, classified as secondary plane, is created in step 405 using end points. Usually the non-vertical part plane of a slab is a horizontal part plane. If the physical part representing the slab in the physical model has one or more sides longer than a preset limit, such as 500 mm or a value depending on dimensions of the slab, for example, for each such side a vertical part plane, classified as a secondary plane, is created in step 405 at the side. Further, if it is detected that in the physical model there are multiple (two or more) physical parts of type column along one edge of the non-vertical part plane, a vertical part plane is created at each end point of an initial element corresponding to physical part representing a column. The part plane type may be primary or secondary. It may be that a similar part plane is created also for the initial element for the column type physical part.

When the one or more part planes have been created, each part plane is associated in step 406 with the corresponding physical part in the temporary memory. The association may be added to the memory, after the corresponding points of the part plane, an identifier of the physical part. In an alternative implementation, the part plane is associated with the initial element, which in turn is associated with the physical part thereby associating the part plane with the physical part. The result of step 406 is that one part plane is associated with one physical part but one physical part may be associated with a plurality of part planes.

Although not separately disclosed, when a part plane is created, it may be provided with an identifier.

When all initial members have been processed the intermediate analysis model is ready in the temporary model.

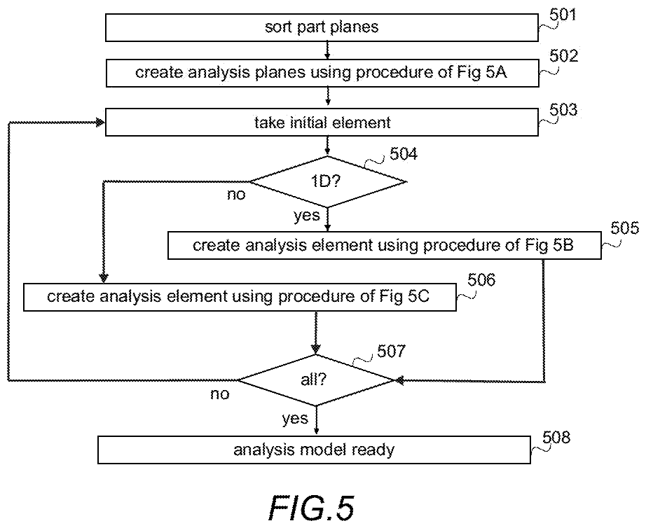

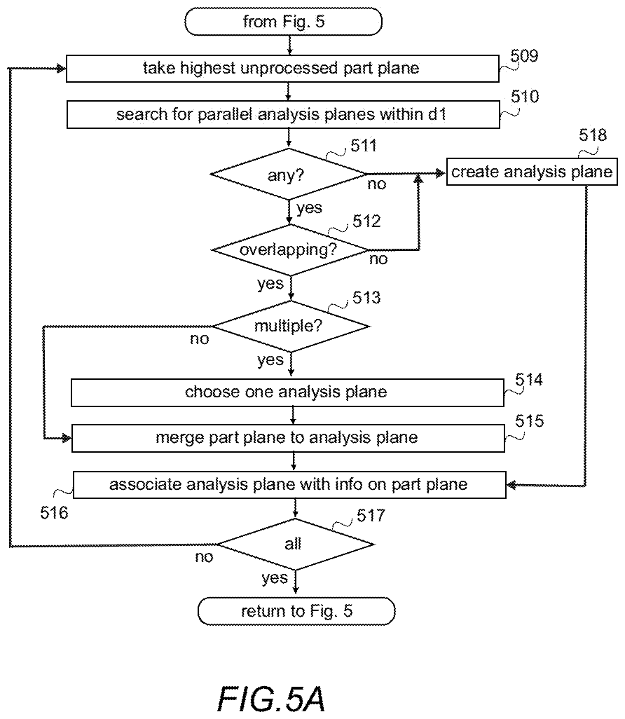

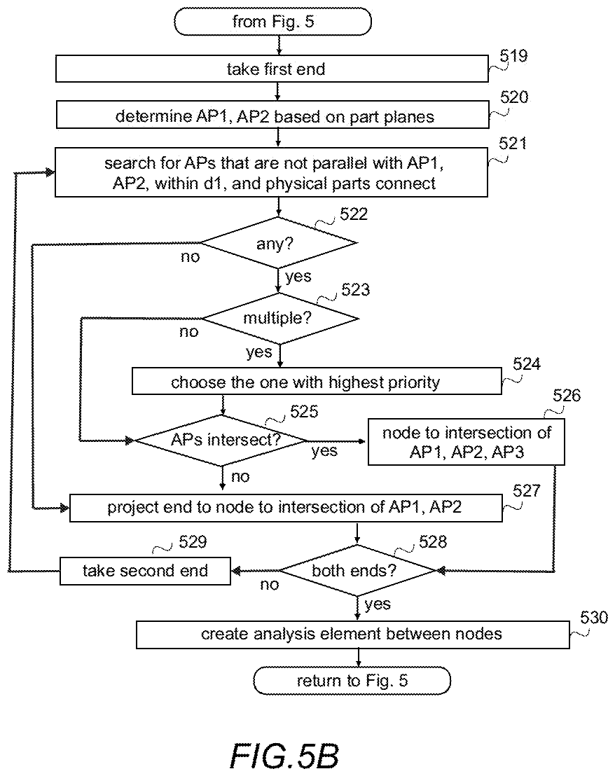

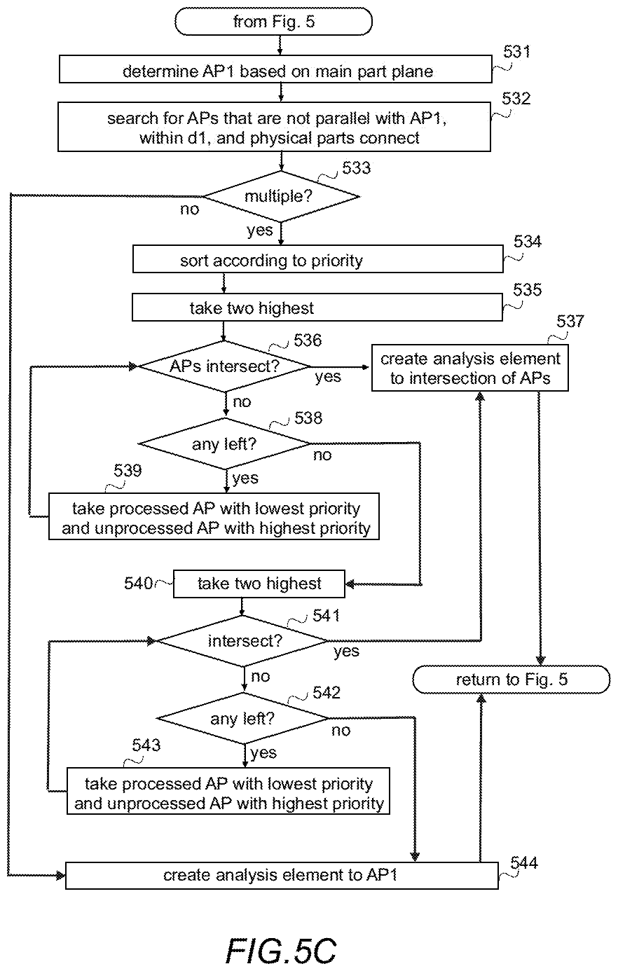

FIGS. 5 to 7 describe alternatives how to process the intermediate analysis model (part planes with information on initial elements and associated physical parts) into an analysis model.

FIG. 5, together with FIGS. 5A, 5B and 5C, is a flow chart illustrating an example of a functionality of an apparatus, or more precisely the merging unit, the example illustrating how to create from part planes analysis elements (from an intermediate analysis model an analysis model for structural analysis). In the process it is assumed that initial elements are maintained in the temporary memory at least until the analysis model is ready.

Referring to FIG. 5, the part planes are first sorted in step 501 to be in a sorted order for the processing. The processing order is that primary part planes are processed first, then the secondary part planes. Within the primary part planes, as well as within the secondary part planes, the sorting order is based on the age of the physical part: oldest is processed first. If part planes are associated with the same physical part, then the part plane having the smaller identifier is processed first. (It is assumed that the part plane having the smaller identifier is created first.) It should be appreciated that the described sorting order is a mere example, and any other sorting order may be used. For example, sorting order may depend on the distances of corresponding physical parts to the ground.

Then analysis planes are created, in step 502, from the part planes in the sorted order, using the process of FIG. 5A. The process will be described below in more detail.

Once the analysis planes have been created, an initial element is taken in step 503 to create an analysis element for the initial element. More precisely, an analysis element representing a corresponding physical part will be created. If the initial element is an 1D initial element (step 504: yes), an analysis element corresponding to the initial element is created in step 505, using the process of FIG. 5B. The process will be described below in more detail. If the initial element is a 2D initial element (step 504: no), an analysis element corresponding to the initial element is created in step 506, using the process of FIG. 5C. The process will be described below in more detail.

Once the analysis element has been created, it is checked in step 507, whether an analysis element has been created for each initial element. If not (step 507: no), the process continues to step 502 to take an initial element to create analysis element for the initial element. If an analysis element has been created to all initial elements (step 507: yes), the analysis model is ready (step 508).

The analysis model may be then inputted to the structural analysis, or outputted via a user interface for a user acceptance, and/or for further manipulation by the user.

If support parts, such as bracing, is added to the analysis model, they may be added by snapping to analysis nodes defined for the analysis elements.

FIG. 5A describes in detail an example of a process performed in step 502 in FIG. 5. In other words, it describes one example how to create analysis planes from part planes.

Referring to FIG. 5A, it is assumed that the part planes are in a sorted order. The illustrated process starts by taking in step 509 the highest one that has not yet undergone the process of FIG. 5A in the sorted order to be processed. For the part plane, parallel analysis planes within a distance d1 are searched for in step 510. As a basic rule, if the part plane is vertical, vertical analysis planes are searched for, and if the part plane is non-vertical, non-vertical analysis planes are searched for. The part planes may be deemed to be parallel for merging purposes if their angle to the same line is substantially perpendicular. For example, if angle difference to the same line between the planes is less than a preset limit, for example 0.8°, the part planes are deemed to be parallel for merging purposes. The distance d1 may have a preset value, or preset values for different types of part planes, or the distance d1 may define distance between the physical parts the parallel planes are associated with. For example, for primary part planes d1 may be 5 mm, and for secondary part planes d1 may be 300 mm with the exception that if the secondary part plane is a vertical part plane for a beam, they are deemed to be within distance d1 if the physical part beam and one of physical parts associated with the analysis plane have a physical connection. In other words, the physical parts either touch each other, or there is, or connectivity information indicate that there will be, a connection (joint) between the physical parts.

In one implementation, there is an exception to the above described basic rule for secondary part planes for a beam, which beam is more horizontal than vertical in the model coordinate system. In such a case a non-vertical analysis plane for a vertical part plane, and a vertical analysis plane for a non-vertical part plane are searched for and can be deemed to be parallel for merging purposes. Further, the angle limit between plane normal of the analysis plane and plane normal of the part plane may be bigger than the one mentioned above and yet the planes can be merged (are deemed to be parallel). The beam may be deemed to be parallel to the analysis plane, when starting and ending points (positions) of the beam are projected to the analysis plane, and the line that connects the projected positions is parallel within a tolerance, which may be much smaller than the tolerance provided by the angle limit between the plane normal of the analysis plane and the plane normal of the part plane, with a vector from the beam ending point to the beam starting point.

If one or more parallel analysis planes within d1 are found (step 511: yes), it is checked in step 512 whether the part plane and any of the found one or more parallel analysis planes are overlapping. The planes may be deemed to be overlapping, if the part plane is projected to the analysis plane, and the projection is expanded by a preset expansion value, for example 300 mm, and after that a polygon of the analysis plane and a polygon of the expanded projection of the part plane intersect.

If there are multiple analysis planes that the part plane is overlapping (step 512: yes, step 513: yes), one of the analysis planes is chosen in step 514 to be the analysis plane with which the plane will be merged. There are no restrictions how to define a selection rule based on which the analysis plane is chosen. The selection rule may be that the closest analysis plane is chosen. In another example the selection rule is that the oldest analysis plane, based on its creation time, is chosen. In a further example the selection rule is that the analysis plane which is associated with a part plane created for oldest physical part is selected and if there are two or more parallel overlapping analysis planes associated via part planes to the same oldest physical part, then the oldest analysis plane amongst the parallel overlapping analysis planes is selected. A still further example is that if the distance between the part plane and the closest analysis plane is more than 5 mm, then the closest analysis plane is chosen, but if the distance is 5 mm or less, the analysis plane which is associated with a part plane created for oldest physical part, is selected and if there are two or more parallel overlapping analysis planes associated via part planes to the same oldest physical part, then the oldest analysis plane amongst the parallel overlapping analysis planes is selected.

Once the analysis plane has been chosen, or if only one analysis plane was found (step 513: no), the part plane is merged in step 515 to the analysis plane, and the analysis plane is associated in step 516 with information on the part plane. This associates the analysis plane to a corresponding physical part. Then the process continues to check, whether all part planes have been processed. If not (step 517: no), the process returns to step 509 to take the highest one that has not yet undergone the process to be processed. If all part planes are processed (step 517: yes), analysis planes are created and the process returns to FIG. 5, to continue in step 503.

If there are no parallel analysis planes (step 511: no), an analysis plane is created from the part plane in step 518, and the process continues to step 516 to associate the analysis plane with information on the part plane.

If there are no overlapping parallel analysis planes (step 512: no), the process continues to step 518 to create an analysis plane from the part plane.

FIG. 5B describes in detail an example of a process performed in step 505 in FIG. 5. In other words, it describes how to create, using the analysis planes, analysis elements for 1D initial elements. FIG. 5B starts in a situation in which an initial 1D element has been selected to undergo the process.

Referring to FIG. 5B, one of the end points (ends) of the initial element is taken in step 519 to be the first end to be processed. As the first step of the process two analysis planes AP1 and AP2 are determined in step 520 based on the part planes created for the initial element. In other words, it is determined with which analysis plane a part plane is associated. If the initial element is for column, the analysis planes, to which the primary part planes are associated with, are determined. If the initial element is for a beam, the analysis planes are determined to both part planes created.

Then a third analysis plane AP3 fulfilling preset criteria (a set of rules) is search for in step 521. The preset criteria may include that the analysis plane should be within a specific distance, for example 1000 mm, from the end point of the initial element, that the analysis plane is not parallel to AP1 or AP2 (using, for example, the above described criteria for parallel planes) and that the physical part, which the initial element represents, connects at least with one of one or more physical parts that are associated with the analysis plane. In other words, the physical parts either touch each other, or there is, or connectivity information indicate that there will be, a connection (joint) between the physical parts.

If more than one analysis planes are found (step 522: yes, step 523: yes), the one with the highest priority is selected in step 524 to be the third analysis plane AP3. The priority may be determined based on the creation order of the analysis planes: the older, the higher the priority. Alternatively, the priority order may be determined based on the highest priority of part planes the analysis plane is associated with. The priority of the part planes may be determined using priority order of classes. The priority order of classes may be as follows, from the highest to the lowest:
primary
secondary beam non-vertical
secondary slab non-vertical
secondary column non-vertical
secondary wall non-vertical
secondary beam vertical
secondary wall vertical
secondary slab side vertical
secondary wall end vertical
if in the same class, the one, whose associated physical part is published (stored) to the model earlier, has a higher priority

Naturally, if only one analysis plane is found (step 522: yes, step 523: no), it is the third analysis plane AP3. When the third analysis plane AP3 is known, it is checked in step 525, whether the three analysis planes AP1, AP2 and AP3 intersect. If they intersect (step 525: yes), an analysis node is determined in step 526 to locate in the intersection. Then it is checked in step 528, whether both end points of the initial element are processed. If not (step 528: no), the other end point, the second end point, is taken in step 529, and then the process returns to step 521 to search the third analysis plane AP3.

If the three analysis planes AP1, AP2, AP3 do not intersect (step 525: no), or if no third analysis plane is found (step 522: no), the end point of the initial element is projected to the intersection of analysis planes AP1 and AP2, and an analysis node is determined in step 527 to locate in the intersection. Then the process continues to step 528 to check, whether both end points of the initial element are processed.

If both end points of the initial element are processed (step 528: yes), an analysis element is created in step 530 between the analysis nodes, and the process returns to FIG. 5.

FIG. 5C describes in detail an example of a process performed in step 506 in FIG. 5. In other words, it describes how to create, using the analysis planes, analysis elements for 2D initial elements. FIG. 5C starts in a situation in which an initial 2D element has been selected to undergo the process.

Referring to FIG. 5C, as the first step of the process, one analysis plane AP1 is determined in step 531 based on a main part plane created for the initial element. If the initial element is for a wall, the analysis plane, to which the vertical plane is associated with, is determined in step 531. If the initial element is for a slab, the analysis plane, to which the non-vertical plane is associated with, is determined in step 531.

Then a second and third analysis planes AP2 and AP3 fulfilling preset criteria (a set of rules) is search for in step 532. The preset criteria may include that the analysis plane should be within a specific distance, for example 1000 mm, from the position of the initial element, that the analysis plane is not parallel to AP1 and that the physical part the initial element represents connects at least with one of one or more physical parts that are associated with the analysis plane. In other words, the physical parts either touch each other, or there is, or connectivity information indicate that there will be, a connection (joint) between the physical parts.

If multiple, i.e. two or more, analysis planes are found (step 533), they are sorted in step 534 according to their priority to be in a priority order. Examples how to determine the priority are described above with FIG. 5B. Naturally, if two analysis planes are found, the sorting step may be skipped over. Then the two highest analysis planes in the sorted order are taken in step 535 to be analysis planes AP2 and AP3, and it is checked in step 536, whether the three analysis planes AP1, AP2 and AP3 intersect. If they do (step 536: yes), an analysis element is created in step 537 to the intersection point, and the process returns to FIG. 5. In other words, this means that the initial 2D element is placed to the intersection and converted to be an analysis element.

If the three analysis planes AP1, AP2 and AP3 do not intersect (step 563: no), it is checked in step 538, whether there are any unprocessed analysis planes in the sorted order of analysis planes. If there are (step 538: yes), from the processed analysis planes the one having the lowest priority is selected in step 539 to be AP2 and from the unprocessed analysis planes the one having the highest priority in the sorted order is selected in step 539 to be AP3. Then the process continues to step 536 to check, whether the analysis planes AP1, AP2, AP3 intersect.

If there are no more unprocessed analysis planes in the sorted order of the analysis planes (step 538: no), then the two having the highest priority are selected in step 540. If the two analysis planes intersect (step 541: yes), the process proceeds to step 537 to create an analysis element to the intersection point.

If the two analysis planes do not intersect (step 541: no) it is checked in step 542, whether there are any analysis planes in the sorted order of analysis planes which has not undergone the process of intersection check of step 541. If there are (step 542: yes), from the unprocessed analysis planes the one having the lowest priority is selected in step 543 to be one of the analysis planes and from the unprocessed analysis planes the one having the highest priority is selected in step 543 to be the other one of the analysis planes. Then the process continues to step 541 to check, whether the two analysis planes intersect.

If there is not any more analysis planes which have not undergone the process of intersection check of step 541 (step 542: no), or if no analysis planes or only one analysis plane was found in step 532 (step 533: no), an analysis element is created in step 544 on the position of the analysis plane AP1, and the process returns to FIG. 5.

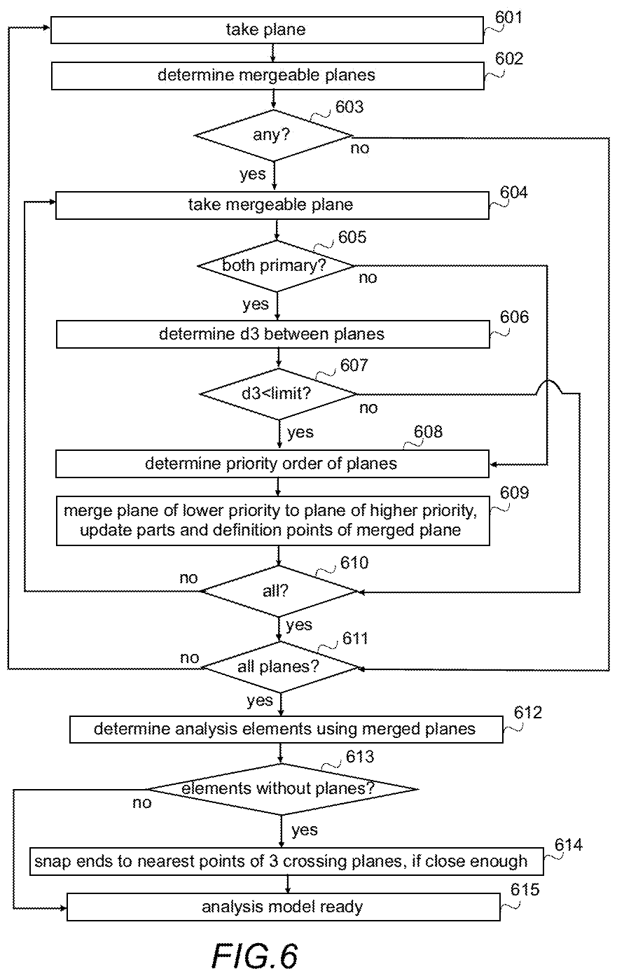

FIG. 6 is a flow chart illustrating another example of a functionality of an apparatus, or more precisely the merging unit, the example illustrating one way how to merge part planes, rules for merging being described with steps 602 and 605 to 609. Although the process is described, for the sake of clarity, as a serial processing, it is obvious for one skilled in the art that the process may be implemented as a parallel processing. In the example, it is assumed that initial elements are created also for structural parts, but no part planes are created for such initial elements.

Referring to FIG. 6, a part plane is taken in step 601 to be processed. Then mergeable planes are determined in step 602. A mergeable plane may be another part plane or a plane formed by merging part planes. For example, a plane fulfilling following rules is determined to be a mergeable plane: it is within 300 mm from the plane taken in step 601 to be processed, planes are parallel and overlap at least partly, and the distance between corresponding end points of physical parts associated with the planes is less than or equal to 25 mm. It should be appreciated that the above values are only examples, and any value may be used.

If any such planes are determined/found (step 603: yes), a mergeable plane is taken in step 604 to be processed, and the types of the planes are compared in step 605 to determine whether or not both are of the primary type. If the type of both planes is the primary type (step 605: yes), a stricter distance limit than the one used for determining mergeable planes. Therefore, distance d3 between the planes are determined in step 606, and then it is checked in step 607, whether the distance is more than zero but less than a predefined limit. The predefined limit may be a 5 mm, for example. If the distance is within the limits (step 607: yes), a priority order of the planes is determined in step 608, using the class of the plane and priority order, that is stored as a part of rules. An example of the priority order of classes is described above with FIG. 5B.

Once the priority order has been determined, the plane having the lower priority order is merged in step 609 to the plane of the higher priority order, and the plane of the higher priority order is associated with the same one or more physical parts the lower priority order plane is associated with, and definition points of the higher priority plane are updated so that the updated plane covers at least the areas of both planes.

After that it is checked in step 610, whether every mergeable plane determined/found in step 602 are processed. If not (step 610: no), the process returns to step 604 to take a mergeable plane to process. If every determined mergeable plane has been processed (step 610: yes), it is checked in step 611, whether or not each plane has been processed, i.e. mergeable planes determined for the plane. If not (step 611: no), the process returns to step 601 to take a next plane to be processed.

If all planes have been processed (step 611: yes), analysis elements are determined in step 612 using merged planes, and their intersections, for example as described above with FIGS. 5B and 5C. Then it is checked in step 613, whether the initial elements contained initial elements for which no planes were created. (They are stored in the temporary memory.) If there are one or more of initial elements without planes (step 613: yes), each of end points of such initial elements are snapped in step 614 to a nearest point that is defined by three crossing planes, on the condition that the distance between an end point of an initial element and the nearest point is within a predefined limit, for example 350 mm. After that the analysis model with analysis elements is ready (step 615) for structural processing. If planes were created for each analysis element (step 613: no), the analysis model is ready (step 615) for structural processing.

If no mergeable planes are found (step 603: no), the process proceeds to step 611 to check, whether or not each plane has been processed.

If one of the planes or none of the planes is primary (step 605: no), the process proceeds directly to step 608 to determine priority order of the planes.

If the distance d3 between the primary planes is bigger than the limit (step 607: no), the primary planes are too far away to be merged. By this check it is ensured that the analysis model reflects the structural model close enough to be reliable for structural analysis. In other words, since the physical model remains the same, i.e. merging the planes and possibly moving end points of initial elements when they are converted into analysis element does not change the physical model, having stricter rules to adjust analysis elements representing load-bearing parts, ensures that the different forces are reflected more properly during the structural analysis.

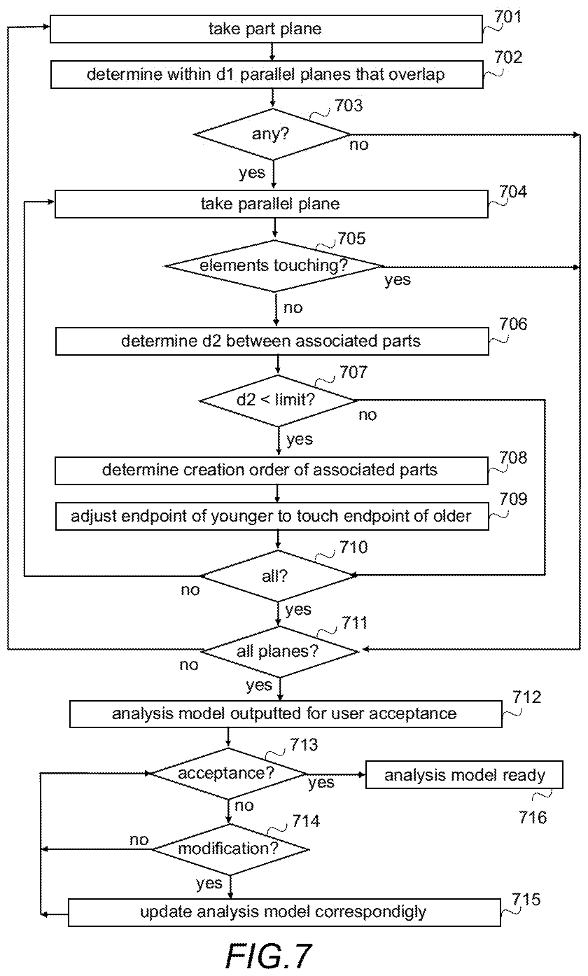

FIG. 7 is a flow chart illustrating a still further example of a functionality of an apparatus, or more precisely the merging unit, the example illustrating one way how to merge part planes, rules for merging being described with steps 702 and 705 to 708. Although the process is described, for the sake of clarity, as a serial processing, it is obvious for one skilled in the art that the process may be implemented as a parallel processing. In the illustrated example, each part plane is also associated with its initial element, i.e. the initial element based on which the plane was created. Since each initial element is associated with its physical part, each part plane is by means of the initial element associated with the physical part.

Referring to FIG. 7, a part plane is taken in step 701 to be processed. Then parallel planes, which overlap and further fulfill a rule that a distance between the planes is within a predefined value d1, are determined (search for) in step 702. By determining parallel planes within the value d1 ensures that only those planes whose initial elements may be combined, since they are close enough, are taken to be processed. In other words, for example in a five story building having five columns above each other and beams between columns, parallel part planes, one created for a column in the first story and one for a beam touching a column in the fifth story, are overlapping, but they will not fulfill the “within the predefined value” rule, and will not be taken into further processing, since the two initial elements should not be combined.

If any such planes are determined/found (step 703: yes), a parallel plane is taken in step 704 and first it is checked in step 705 whether the initial elements in the planes already are touching each other. If not (step 705: no), a distance d2 between an associated physical part of the parallel plane and an associated physical part of the plane taken in step 701 is determined in step 706. Then the distance d2 is compared in step 707 with a limit. The limit may be 25 mm, for example. With the comparison and the limit it is ensured that the physical parts touch each other in the model, or are at least close enough, so that modeling tolerances can be taken into account.

If the physical parts touch each other or are close enough (step 707: yes), the creation order of the associated physical parts is determined in step 708 and the initial element corresponding to the younger physical part is adjusted in step 709 to touch the initial element corresponding to the older physical part. More precisely, the end point of the younger, which end point faces towards the initial element corresponding to the older physical part, is extended/moved to touch the corresponding end point of the older, i.e. the end point, which faces towards the initial element corresponding the younger physical part.

After that it is checked in step 710, whether every parallel plane determined/found in step 702 are processed. If not (step 710: no), the process returns to step 704 to take a parallel plane to process. If every determined parallel plane have been processed (step 710: yes), it is checked in step 711, whether or not each part plane has been processed, i.e. whether parallel planes have been determined for each part plane. If not (step 711: no), the process returns to step 701 to take a next part plane to be processed.

If all part planes have been processed (step 711: yes), the analysis model comprising the adjusted initial elements as analysis elements is outputted in step 712 via a user interface for a user acceptance. Then it is monitored, whether a user input indicating an acceptance (step 713) or a modification to the analysis model (step 714). If a modification of an analysis element is received (step 714: yes), the analysis model is updated in step 715 correspondingly, and then the process returns monitoring whether an acceptance (step 713) or modification (step 714) is received.

If an acceptance is received (step 713: yes), the analysis model is ready for structural analysis. The structural analysis may be performed immediately, or the analysis model may be published (stored) to undergo the structural analysis later.

The steps and related functions described above in FIGS. 3 to 7 are in no absolute chronological order, and some of the steps may be performed simultaneously or in an order differing from the given one. Other functions can also be executed between the steps or within the steps. For example, part planes may be created for support structures as well. In another example, before starting the process different values used in the rules for offsets and distances, for example, may be outputted to the user so that the user may change them. Further, alternative ways for user input providing one or more of the values may be used. Some of the steps or part of the steps can also be left out or replaced by a corresponding step or part of the step. For example, it may be that no initial elements are created but the part planes are created directly using the physical parts.

The techniques described herein may be implemented by various means so that an apparatus implementing one or more functions/operations described above with an embodiment/example, for example by means of any of FIGS. 1A to 7 and any combination thereof. For example, one or more of the means and/or merging unit and/or plane creation unit for one or more functions/operations described above may be software and/or software-hardware and/or hardware and/or firmware components (recorded indelibly on a medium such as read-only-memory or embodied in hard-wired computer circuitry) or combinations thereof. Software codes may be stored in any suitable, processor/computer-readable data storage medium(s) or memory unit(s) or article(s) of manufacture and executed by one or more processors/computers, hardware (one or more apparatuses), firmware (one or more apparatuses), software (one or more modules), or combinations thereof. For a firmware or software, implementation can be through modules (e.g., procedures, functions, and so on) that perform the functions described herein.

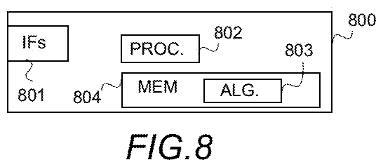

FIG. 8 is a simplified block diagram illustrating some units for an apparatus (computing device) 800 comprising the analysis model creation unit and/or merging unit and/or plane creation unit, or configured otherwise to perform at least some functionality described above, for example by means of any of FIGS. 1A to 7 and any combination thereof, or some of the functionalities if functionalities are distributed in the future. In the illustrated example, the apparatus comprises one or more interface (IF) entities 801, one or more processing entities 802 connected to various interface entities 801 and to one or more memories 804.

The one or more interface entities 801 are entities for receiving and transmitting information, such as communication interfaces comprising hardware and/or software for realizing communication connectivity according to one or more communication protocols, or for realizing data storing and fetching, or input/output interfaces comprising hardware and/or software for realizing connectivity to input/output devices for various types of inputs and outputs. Examples of input/output devices include a touchscreen, keypad, microphone, mouse, (wearable) augmented reality device, (wearable) virtual reality device, integrated display device, external display device, audio speakers/headphones and a printer.

A processing entity 802 is capable to perform calculations and configured to implement at least the analysis model creation unit and/or merging unit and/or plane creation unit, described herein, or at least part of functionalities/operations described above, for example by means of any of FIGS. 1A to 7 and any combination thereof, as a corresponding unit or a sub-unit if distributed scenario is implemented, with corresponding algorithms 803 stored in the memory 804. The entity 802 may include a processor, controller, control unit, micro-controller, unit, module, etc. suitable for carrying out embodiments or operations described above, for example by means of any of FIGS. 1A to 7 and any combination thereof. The processor may be a central processing unit, a graphics processing unit, or a combination of different processing units, such as a central processing unit configured to operate in conjunction with a graphics processing unit. In general, the processing entity 802 may be any technically feasible hardware unit capable of processing data and/or executing software applications.

A memory 804 is usable for storing a computer program code required for the analysis model creation unit and/or merging unit and/or plane creation unit, or a corresponding unit or sub-unit, or for one or more functionalities/operations described above, for example by means of any of FIGS. 1A to 7 and any combination thereof, i.e. the algorithms for implementing the functionality/operations described above by means of any of FIGS. 1A to 7 and any combination thereof. The memory 804 may also be usable for storing other possible information, like the temporarily stored information.

As a summary, each or some or one of the units/sub-units and/or algorithms for functions/operations described herein, for example by means of means of any of FIGS. 1A to 7 and any combination thereof, may be configured as a computer or a processor, or a microprocessor, such as a single-chip computer element, or as a chipset, or one or more logic gates including at least a memory for providing storage area used for arithmetic operation and an operation processor for executing the arithmetic operation. Each or some or one of the units/sub-units and/or algorithms for functions/operations described above, for example by means of means of any of FIGS. 1A to 7 and any combination thereof, may comprise one or more computer processors, application-specific integrated circuits (ASIC), digital signal processors (DSP), digital signal processing devices (DSPD), programmable logic devices (PLD), field-programmable gate arrays (FPGA), and/or other hardware components that have been programmed and/or will be programmed by downloading computer program code (one or more algorithms) in such a way to carry out one or more functions of one or more embodiments/examples.

An embodiment provides a computer program embodied on any client-readable distribution/data storage medium or memory unit(s) or article(s) of manufacture, comprising program instructions executable by one or more processors/computers, which instructions, when loaded into an apparatus, constitute the analysis model creation unit and/or merging unit and/or plane creation unit or an entity providing corresponding functionality, or at least part of the corresponding functionality. Programs, also called program products, including software routines, program snippets constituting “program libraries”, applets and macros, can be stored in any medium and may be downloaded into an apparatus. In other words, each or some or one of the units/sub-units and/or the algorithms for one or more functions/operations described above, for example by means of means of any of FIGS. 1A to 7 and any combination thereof, may be an element that comprises one or more arithmetic logic units, a number of special registers and control circuits.

It will be obvious to a person skilled in the art that, as the technology advances, the inventive concept can be implemented in various ways. The invention and its embodiments are not limited to the examples described above but may vary within the scope of the claims.

What is claimed is:

1. A computer implemented method for automatically creating from a physical model, which is a digital representation of a structure and comprises in a digital form a plurality of physical parts, an analysis model for structural analysis of the structure, the method comprising:
running in a computer an analysis tool application configured to automatically create analysis models from physical models;
retrieving, by the analysis tool application, the physical model;
determining at least for each load-bearing physical part in the physical model an initial element;
determining for each initial element at least one part plane, which is a finite plane;
sorting the part planes to a sorted order;
performing for each part plane according to the sorted order the following: searching for analysis planes that are according to a first set of rules mergeable; if one or more analysis planes are found, merging the part plane to one of the one or more analysis planes, else creating an analysis plane from the part plane;
creating, for the analysis model, analysis elements by adjusting the initial elements based on intersections of analysis planes; and
outputting the analysis model comprising the analysis elements for structural analysis.

2. The computer implemented method of claim 1,
wherein the determining of an initial element comprises:
determining for each longitudinal load-bearing physical part an initial element which is an 1D element; and
determining for each planar load-bearing physical part an initial element which is a 2D element.

3. The computer implemented method of claim 2, wherein a part plane determined for an 1D initial element is a finite rectangular plane having four definition points defined using the 1D initial element and one or more offset values, and a part plane determined for an 2D element is a finite plane, which covers larger area than the physical planar element and has boundaries defined based on boundaries of the physical planar element and one or more offsets.

4. The computer implemented method of claim 1, further comprising associating an analysis plane with information on part planes merged to it and information on a part plane from which the analysis plane is created.

5. The computer implemented method of claim 4, wherein the creating analysis elements by adjusting the initial elements based on intersections of analysis planes comprises for an 1D initial element the following:
determining two analysis planes associated with part planes created for the 1D initial element;
searching for each end point of the 1D initial element an analysis plane fulfilling a second set of rules;
if found, creating for the corresponding end point an analysis node to the intersection of the two analysis planes and one of the found one or more analysis planes;
if not found, creating for the corresponding end point an analysis node by projecting the end point to the intersection of the two analysis planes; and
creating an analysis element between the two analysis nodes.

6. The computer implemented method of claim 5, wherein the second set of rules comprises that an analysis plane is not parallel with the two analysis planes, the analysis plane is within a predetermined distance from a corresponding end point and two of corresponding two or more physical parts connect.

7. The computer implemented method of claim 4, wherein the creating analysis elements by adjusting the initial elements based on intersections of analysis planes comprises for a 2D initial element the following:
determining one analysis plane associated with a part plane created for the 2D initial element;
searching for two analysis planes fulfilling a third set of rules;
if found, creating an analysis element to the intersection of the one analysis plane and the two analysis planes; and
if not found, creating an analysis element to the one part plane.

8. The computer implemented method of claim 7, wherein the third set of rules comprises that an analysis plane is not parallel with the one analysis planes, is within a predetermined distance from a position of the 2D initial element and two of corresponding two or more physical parts connect.

9. The computer implemented method of claim 1, wherein the determining for each initial element at least one part plane comprises:
determining a type of a physical part for which the initial element is determined;
if the type is column, creating at least two primary vertical part planes and two primary non-vertical part planes in a local coordinate system of the initial element;
if the type is beam, creating at least one primary vertical part plane and one primary non-vertical part plane in a local coordinate system of the initial element;
if the type is wall, creating at least three secondary vertical planes and two secondary non-vertical planes in a local coordinate system of the initial element; and
if the type is slab, creating at least one secondary non-vertical plane in a local coordinate system of the initial element.

10. The computer implemented method of claim 1, wherein the first set of rules comprises that an analysis plane and a part plane are mergeable if they are parallel within a tolerance, overlap at least partly, are within a predetermined distance from each other and two of corresponding two or more physical parts connect.

11. The computer implemented method of claim 1, further comprising associating an analysis plane with information on part planes merged to the analysis plane and information on a part plane from which the analysis plane is created.

12. The computer implemented method of claim 1, further comprising:
outputting the analysis model via a user interface to a user for acceptance.

13. A computer implemented method for automatically creating from a physical model, which is a digital representation of a structure and comprises in a digital form a plurality of physical parts, an analysis model for structural analysis of the structure, the method comprising:
running in a computer an analysis tool application configured to automatically create from physical models analysis models, which comprise analysis elements;
retrieving, by the analysis tool application, the physical model;
determining at least for each load-bearing physical part in the physical model at least one part plane, which is a finite plane covering an area bigger than the physical part;
checking for each part plane whether there exists, according to a first set of rules, one or more parallel and overlapping part planes, and if there is, merging the part plane and at least one of the one or more parallel and overlapping part planes;
treating each part plane which is not merged, as a merged plane;
determining, for an analysis model, analysis elements using intersections of merged planes; and
outputting the analysis model comprising the analysis elements for the structural analysis.

14. An apparatus comprising
at least one processor; and
at least one memory including computer program code;
the at least one memory and computer program code configured to, with the at least one processor, cause the apparatus at least to:
retrieve a physical model, which is a digital representation of a structure and comprises in a digital form a plurality of physical parts;
determine at least for each load-bearing physical part in the physical model an initial element;
determine for each initial element at least one part plane, which is a finite plane;
sort the part planes to a sorted order;
perform for each part plane according to the sorted order the following: searching for analysis planes that are according to a first set of rules mergeable; if one or more analysis planes are found, merging the part plane to one of the one or more analysis planes, else creating an analysis plane from the part plane;
create, for the analysis model, analysis elements by adjusting the initial elements based on intersections of analysis planes; and
output the analysis model comprising the analysis elements for structural analysis.

15. The apparatus of claim 14, wherein the at least one memory and computer program code configured to, with the at least one processor, further cause the apparatus at least to:
determine for each longitudinal load-bearing physical part an initial element which is an 1D element; and
determine for each planar load-bearing physical part an initial element which is a 2D element.

16. The apparatus of claim 14, wherein the at least one memory and computer program code configured to, with the at least one processor, further cause the apparatus at least to:
determine a type of a physical part for which the initial element is determined; and
use the type in determining for each initial element the at least one part plane by performing one of:
creating, in response to the type being column, at least two primary vertical part planes and two primary non-vertical part planes in a local coordinate system of the initial element;
creating, in response to the type being beam, at least one primary vertical part plane and one primary non-vertical part plane in a local coordinate system of the initial element;
creating, in response to the type being wall, at least three secondary vertical planes and two secondary non-vertical planes in a local coordinate system of the initial element; and
creating, in response to the type being slab, at least one secondary non-vertical plane in a local coordinate system of the initial element.

17. The apparatus of claim 14, wherein the at least one memory and computer program code configured to, with the at least one processor, further cause the apparatus at least to apply as the first set of rules at least the following: an analysis plane and a part plane are mergeable if they are parallel within a tolerance, overlap at least partly, are within a predetermined distance from each other and two of corresponding two or more physical parts connect.

18. The apparatus of claim 14, wherein the at least one memory and computer program code configured to, with the at least one processor, further cause the apparatus at least to associate an analysis plane with information on part planes merged to the analysis plane and information on a part plane from which the analysis plane is created.

19. The apparatus of claim 14, wherein the at least one memory and computer program code configured to, with the at least one processor, further cause the apparatus to perform at least one of:
determining for each longitudinal load-bearing physical part an initial element which is an 1D element, which is a finite rectangular plane having four definition points defined using the 1D initial element and one or more offset values;
determining for each planar load-bearing physical part an initial element which is a 2D element, which is a finite plane, which covers larger area than the physical planar element and has boundaries defined based on boundaries of the physical planar element and one or more offsets;
associating an analysis plane with information on part planes merged to it and information on a part plane from which the analysis plane is created;
performing, for an 1D initial element, creating analysis elements by adjusting the initial elements based on intersections of analysis planes by determining two analysis planes associated with part planes created for the 1D initial element, searching for each end point of the 1D initial element an analysis plane fulfilling a second set of rules, creating, in response to finding an analysis plane fulfilling the second set of rules, for the corresponding end point an analysis node to the intersection of the two analysis planes and one of the found one or more analysis planes, creating, in response to not finding an analysis plane fulfilling the second set of rules, for the corresponding end point an analysis node by projecting the end point to the intersection of the two analysis planes, and creating an analysis element between the two analysis nodes, wherein the second set of rules comprises that an analysis plane is not parallel with the two analysis planes, the analysis plane is within a predetermined distance from a corresponding end point and two of corresponding two or more physical parts connect; and
performing, for a 2D initial element, creating analysis elements by adjusting the initial elements based on intersections of analysis planes comprises for a 2D initial element by determining one analysis plane associated with a part plane created for the 2D initial element, searching for two analysis planes fulfilling a third set of rules, creating, in response to finding two analysis planes fulfilling the third set of rules, an analysis element to the intersection of the one analysis plane and the two analysis planes, creating, in response to not finding two analysis planes fulfilling the third set of rules, an analysis element to the one part plane, wherein the third set of rules comprises that an analysis plane is not parallel with the one analysis planes, is within a predetermined distance from a position of the 2D initial element and two of corresponding two or more physical parts connect.

20. A non-transitory computer readable medium comprising program instructions for causing, when executed by a computing device, the computing device to create analysis elements forming an analysis model for structural analysis of a structure by performing:
determining, from a physical model, which is a digital representation of the structure and comprises in a digital form a plurality of physical parts, at least for each load-bearing physical part in the physical model an initial element;
determining for each initial element at least one part plane, which is a finite plane;
sorting the part planes to a sorted order;
performing for each part plane according to the sorted order the following: searching for analysis planes that are according to a first set of rules mergeable; if one or more analysis planes are found, merging the part plane to one of the one or more analysis planes, else creating an analysis plane from the part plane; and
creating analysis elements for the analysis model by adjusting the initial elements based on intersections of analysis planes.

21. A non-transitory computer readable medium comprising program instructions for causing, when executed by a computing device, the computing device to create analysis elements forming an analysis model for structural analysis of a structure by performing:
determining, from a physical model, which is a digital representation of the structure and comprises in a digital form a plurality of physical parts, at least for each load-bearing physical part in the physical model at least one part plane, which is a finite plane covering an area bigger than the physical part;
checking for each part plane whether there exists, according to a first set of rules, one or more parallel and overlapping part planes, and if there is, merging the part plane and at least one of the one or more parallel and overlapping part planes;
treating each part plane which is not merged, as a merged plane;
determining analysis elements for the analysis model using intersections of merged planes.
